(19) United States
(12) Patent Application Publication
(10) Pub. No.: US 2014/0295257 A1
(43) Pub. Date: Oct. 2, 2014

(54) BATTERY PACK AND ELECTRIC DEVICE

(71) Applicant: HITACHI KOKI CO., LTD., Tokyo (JP)

(72) Inventor: Tetsuhiro HARADA, Hitachinaka (JP)

(73) Assignee: HITACHI KOKI CO., LTD., Tokyo (JP)

(21) Appl. No.: 14/174,596

(22) Filed: Feb. 6, 2014

(30) Foreign Application Priority Data
Mar. 29, 2013 (JP) 2013-073565

(51) Int. Cl. H01M 2/08

(52) U.S. Cl. CPC H01M 2/08
USPC 429/179

(57) ABSTRACT

A battery pack that can seal a battery cell is provided. The battery pack includes: a housing case that can house a battery cell and can be attached to and detached from a tool main body; a circuit board that retains a battery-side terminal connected to the battery cell; a sealed container that covers the battery cell; an opening portion that is provided on the sealed container and exposes the battery-side terminal to outside of the sealed container; and a bonding part that seals the part between an edge forming the opening portion and the circuit board.

### CROSS-REFERENCE TO RELATED APPLICATION

The present application claims priority from Japanese Patent Application No. 2013-073565 filed on Mar. 29, 2013, the content of which is hereby incorporated by reference into this application.

### TECHNICAL FIELD OF THE INVENTION

The present invention relates to a battery pack that houses a battery cell (s) and to an electric device to/from which the battery pack is attached/detached.

### BACKGROUND OF THE INVENTION

Conventionally, a battery pack that houses a battery cell(s) has been known, and an example of an electric device to/from which the battery pack is attached/detached is described in Japanese Patent Application Laid-Open Publication No. 2002-254356 (Patent Document 1). The electric device described in Patent Document 1 is a striking tool, wherein a battery pack is attached/detached to/from a grip of the striking tool. A motor is provided in the striking tool, and a switch terminal part is provided in the grip of the striking tool. When the battery pack is attached to the grip of the striking tool, the battery pack is connected to the terminal part. Furthermore, a rubber-like elastic body is formed by a two-layer molding process at the part of the grip to/from which the battery pack is attached/detached. The striking tool described in Patent Document 1 can seal the connecting part between the switch terminal and the battery pack.

### SUMMARY OF THE INVENTION

However, the battery pack and the electric device described in Patent Document 1 cannot seal the battery cell(s) housed in the battery pack.

It is an object of the present invention to provide a battery pack and an electric device that can seal a battery cell(s).

A battery pack of an embodiment includes: a housing case that houses a battery cell and can be attached to and detached from an electric-device main body; a retaining member that retains a battery-side terminal connected to the battery cell; a covering container that is housed in the housing case and covers the battery cell; a window part that is provided on the covering container and exposes the battery-side terminal to outside of the covering container; and a seal part that seals a part between an edge forming the window part and the retaining member.

A battery pack of another embodiment includes: a housing case that houses a battery cell and can be attached to and detached from an electric-device main body; a retaining member that retains a battery-side terminal connected to the battery cell; a covering container that covers the battery cell; a window part that is provided on the covering container and exposes the battery-side terminal to outside of the covering container; a case that includes a case main body having an opening portion in an upper side and housing the covering container, and a cover covering the opening portion and provided with a terminal insertion hole exposing the battery-side terminal to outside of the case main body; and a seal part that prevents a foreign matter from entering inside of the covering container through the window part.

An electric device of still another embodiment includes: a battery pack including a housing case that houses a battery cell and can be attached to and detached from an electric-device main body, a retaining member that retains a battery-side terminal connected to the battery cell, a covering container that is housed in the housing case and covers the battery cell, a window part that is provided on the covering container and exposes the battery-side terminal to outside of the covering container, and a seal part that seals apart between an edge forming the window part and the retaining member; and an electric-device main body to and from which the battery pack can be attached and detached. According to the battery pack of the present invention, the part between the circuit board and the covering container can be sealed, and the sealing property of the battery pack is improved.

### BRIEF DESCRIPTIONS OF THE DRAWINGS

FIG. 1 is a perspective view showing an electric power tool, which is an example of an electric device of the present invention;

FIG. 2 is a perspective view showing a state in which a battery pack of the present invention is assembled;

FIG. 3 is an exploded perspective view of the battery pack of the present invention;

FIG. 4 is a schematic perspective view of a sealed container housed in the battery pack of the present invention;

FIG. 5 is a vertical cross-sectional view showing the battery pack of the present invention;

FIG. 6 is an enlarged cross-sectional view of the battery pack shown in FIG. 5;

FIG. 7 is a schematic plan view of the sealed container shown in FIG. 4;

FIG. 8 is a bottom view showing a cover of the battery pack of FIG. 3;

FIG. 9 is an enlarged cross-sectional view showing a structure example of the battery pack of the present invention;

FIG. 10 is an enlarged cross-sectional view showing another structure example of the battery pack of the present invention;

FIG. 11 is an enlarged cross-sectional view showing another structure example of the battery pack of the present invention;

FIG. 12 is an enlarged cross-sectional view showing the sealed container used in the battery pack of the present invention;

FIG. 13 is an enlarged cross-sectional view showing another structure example of the battery pack of the present invention;

FIG. 14 is an enlarged cross-sectional view showing another structure example of the battery pack of the present invention;

FIG. 15 is a plan view showing another structure example of a fixing member used in the battery pack of the present invention;

FIG. 16 is a cross-sectional view showing a manufacturing example of the sealed container used in the battery pack of the present invention; and

FIG. 17 is a cross-sectional view showing another manufacturing example of the sealed container used in the battery pack of the present invention.

### DESCRIPTIONS OF THE PREFERRED EMBODIMENTS

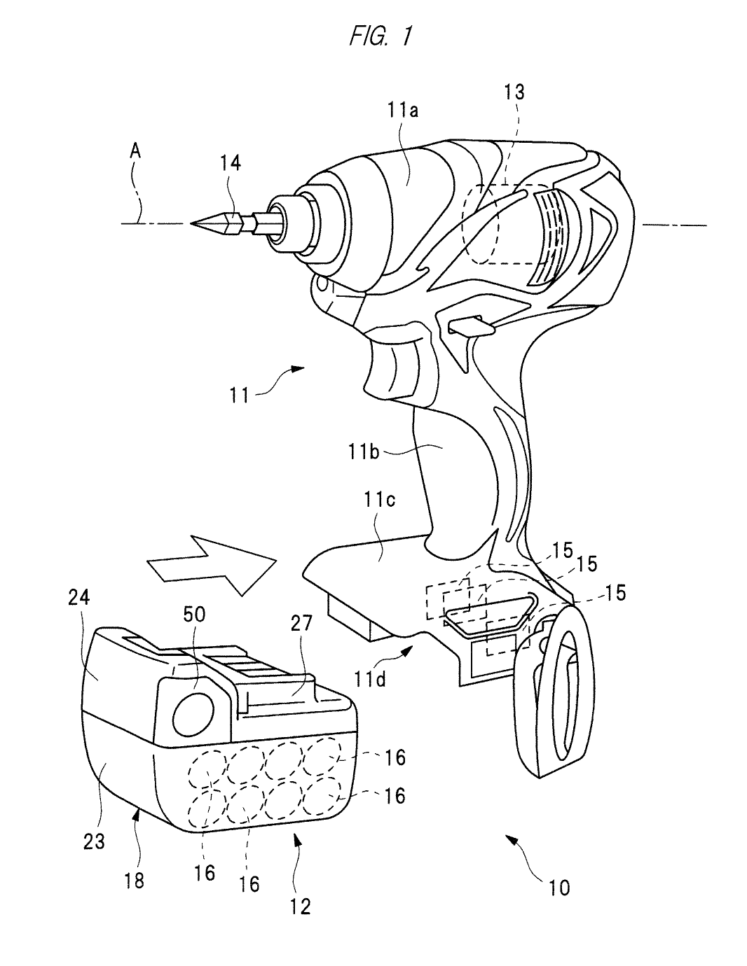

An embodiment of an electric device and a battery pack of the present invention will be explained in detail with reference to the drawings. FIG. 1 shows a schematic configuration of an electric power tool 10, which is an example of the electric device. The electric power tool 10 has a tool main body 11 and a battery pack 12. The tool main body 11 is a main body of the electric device (hereinafter, called electric-device main body) of the present invention, and the battery pack 12 is attachable to and detachable from the tool main body 11. The tool main body 11 is provided with a casing 11a, a grip part 11b, and an attachment part 11c. An electric motor 13 is housed in the casing 11a. The casing 11a is configured so that a tip tool 14 can be attached and detached thereto/therefrom. When motive power from the electric motor 13 is transmitted, the tip tool 14 carries out rotary motion or reciprocating motion about an axis line A. Specifically, examples of the electric power tool 10 include impact drivers, drills, drivers, hammers, hammer drills, and hammer drivers.

The casing 11a is connected to a first end of the grip part 11b, and the attachment part 11c is provided at a second end of the grip part 11b. In the grip part 11b, a control board, which controls the electric motor 13, is provided. In the attachment part 11c, a plurality of, specifically, three tool-side terminals 15 are provided. The battery pack 12 can be attached to and detached from the attachment part 11c.

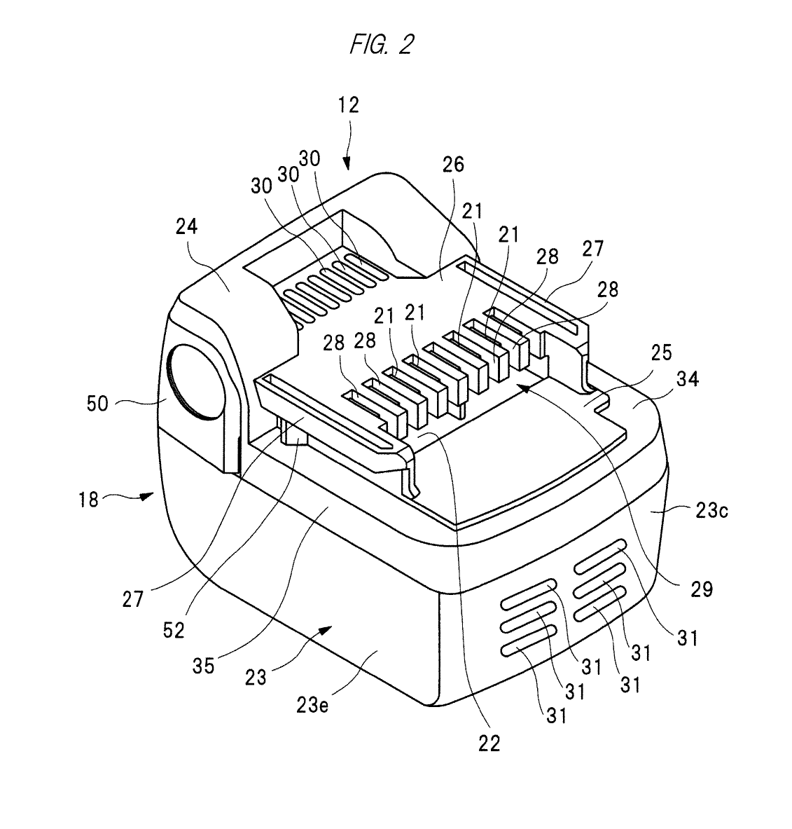

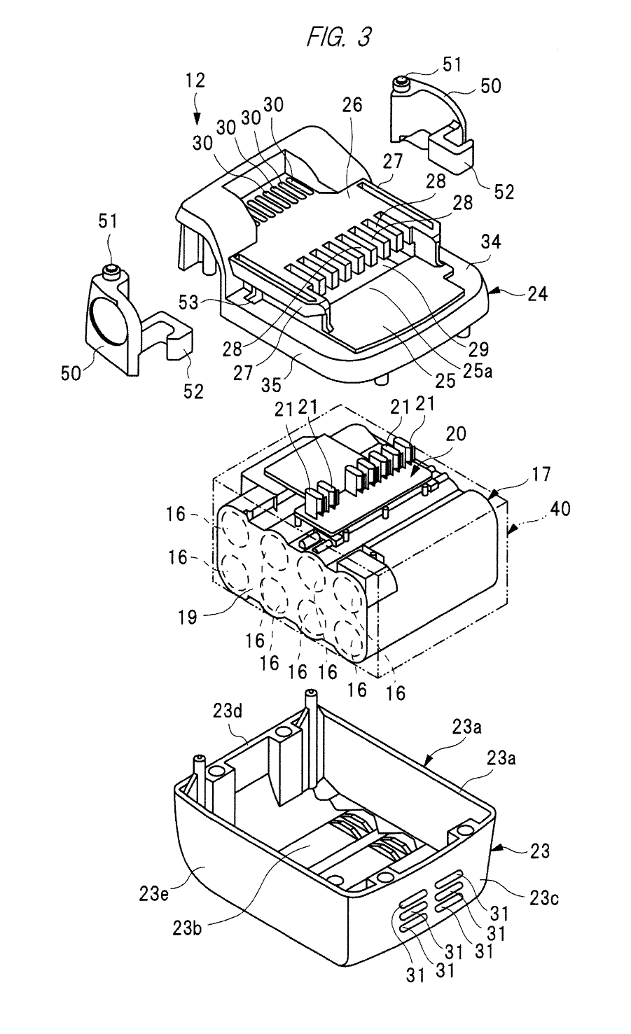

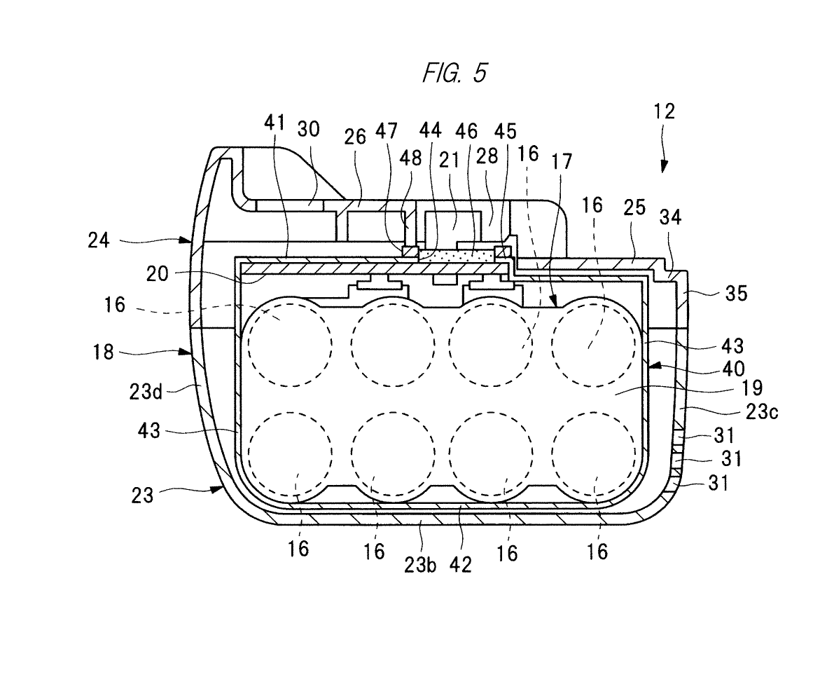

The configuration of the battery pack 12 will be explained with reference to FIG. 2, FIG. 3, FIG. 5, and FIG. 8. The battery pack 12 has a plurality of battery cells 16, a holder 17, and a housing case 18. The battery cells 16 are secondary batteries which can repeatedly carry out charge and discharge. Examples of the battery cells 16 include lithium-ion battery cells, nickel-hydrogen battery cells, lithium-ion polymer battery cells, and nickel-cadmium battery cells.

The holder 17 retains the plurality of cylindrical battery cells 16 aligned in parallel. In the holder 17 of the present embodiment, four battery cells 16 are aligned in parallel to form one row, and the eight battery cells 16 in two rows are housed therein. The four battery cells 16 form one set, and each of the two sets of the battery cells 16 is individually serially connected. A first connecting member is connected to a positive electrode of the battery cell 16 positioned at a first end among the four serially connected battery cells 16 of each set. On the other hand, a second connecting member is connected to a negative electrode of the battery cell 16 positioned at a second end among the four serially connected battery cells 16 of each set.

In the present embodiment, the connecting members, which mutually electrically connect electrodes, are composed of a metal material having electrical conductivity. Examples of this metal material include copper, aluminum, etc. and a material which is a rolled steel plate having a nickel-plated surface. An opening portion of the holder 17 is covered by an insulating member 19. Examples of the material constituting the insulating member 19 include an insulating tape using a resin film as a base material, an insulating sheet or a rubber-like elastic body, and a metal plate having a surface on which an insulating layer composed of a resin material is formed.

Furthermore, a circuit board 20 is attached to an outer side of a body part of the holder 17. The circuit board 20 has been formed into a plate shape by an electrically non-conductive resin material. On the circuit board 20, an electric circuit connected to battery-side terminals 21 is formed. The electrical circuit is formed of an electrically-conductive metal; however, for the sake of convenience, the electrical circuit is not shown in the drawings. The plurality of battery-side terminals 21 are attached on the surface of the circuit board 20 that is positioned in the opposite side of the holder 17. The battery-side terminals 21 are composed of an electrically-conductive metal material. The above-described first connecting member and the second connecting member are connected to the battery-side terminals 21 via lead wires. The circuit board 20 corresponds to a retaining member of the present invention. The battery-side terminals 21 are not required to be directly connected to the circuit board 20, and the circuit board 20 and a terminal retaining part may be separately provided.

A housing case 18 houses the holder 17 retaining the plurality of battery cells 16 and the circuit board 20. The housing case 18 has a case main body 23 and a cover 24 covering an opening portion 23a of the case main body 23. All of the holder 17, the case main body 23, and the cover 24 are mutually separately formed of an electrically non-conductive material such as a resin. The case main body 23 has a bottom part 23b, a front wall 23c formed to be continued to an outer peripheral edge of the bottom part 23b, a rear wall 23d, and two lateral walls 23e. When the case main body 23 is viewed in a plan view, the bottom part 23b is approximately rectangular. The front wall 23c and the rear wall 23d are connected to two parallel sides of the bottom part 23b and extended so as to be approximately orthogonal to the bottom part 23b. Thus, the front wall 23c and the rear wall 23d are approximately parallel to each other. The two lateral walls 23e are connected to two parallel sides of the bottom part 23b and are extended so as to be approximately orthogonal to the bottom part 23b. The two lateral walls 23e are approximately parallel to each other. The two lateral walls 23e are provided so as to be opposed to longitudinal-direction ends of the battery cells 16. In the bottom part 23b, the two sides to which the front wall 23c and the rear wall 23d are connected and the two sides to which the two lateral walls 23e are connected are different.

Furthermore, in the front wall 23c, a plurality of vent holes 31, which communicate the inside and outside of the housing case 18 to each other, are provided. In other words, the plurality of vent holes 31 are provided to penetrate through the front wall 23c in the thickness direction thereof. The plurality of vent holes 31 are passages which discharge the air in the housing case 18 to outside.

On the other hand, the cover 24 has a base part 34, and a plate part 25 and a mount part 26 are provided on the base part 34. In a state in which the cover 24 is attached to the case main body 23, the plate part 25 has a flat-plate shape which is approximately parallel to the bottom part 23b. In a state in which the cover 24 is attached to the case main body 23, the mount part 26 is projecting to the upper side from the plate part 25. In both sides of the mount part 26, guide rails 27, which are used to attach the battery pack 12 to the tool main body 11, are respectively provided. The two guide rails 27 are disposed to be parallel to each other.

Between the two guide rails 27 of the mount part 26, a plurality of terminal insertion holes 28 are provided. The plurality of terminal insertion holes 28 penetrate therethrough like slits from the inside to outside of the housing case 18. The plurality of terminal insertion holes 28 are disposed to be parallel to the guide rails 27. Furthermore, the plurality of terminal insertion holes 28 are disposed in one row between one of the guide rails 27 and the other guide rail 27. When the housing case 18 is viewed in a plan view in a state in which the cover 24 is attached to the case main body 23, the plurality of terminal insertion holes 28 are disposed immediately above the plurality of battery-side terminals 21. When the cover 24 is viewed from the lower side, a rib 48 surrounding the plurality of battery-side terminals 21 from three directions is provided. The rib 48 is provided in a U-shape so as to exclude the part along a window 29 as shown in FIG. 8. The rib 48 corresponds to a holding part of the present invention. At a boundary part of the mount part 26 and the plate part 25, the window 29 is provided. When the cover 24 is viewed in a plan view, the window 29 is linearly extended in a direction approximately orthogonal to the two guide rails 27. An edge 25a of the plate part 25 is linearly provided along the window 29. The edge 25a is linearly extended in a direction approximately orthogonal to the guide rails 27. The window 29 is connected to the plurality of terminal insertion holes 28. Furthermore, in a state in which the cover 24 is attached to the case main body 23, the plurality of battery-side terminals 21 are inserted in the plurality of terminal insertion holes 28. Furthermore, a plurality of vent holes 30, which communicate the inside and outside of the housing case 18 to each other, are provided on the cover 24.

Furthermore, operation buttons 50 are attached to the cover 24. The operation button 50 can be rotated by using a supporting shaft 51 as a supporting point, and the operation button 50 is provided with a latch 52. Holes 53 are provided on the cover 24. When the cover 24 is attached to the case main body 23, part (claw part) of the latch 52 is exposed to the outside of the cover 24 from the hole 53. The attachment part 11c is provided with grooves so that the claws of the latches 52 are engaged with the grooves.

Next, an operation of attaching the battery pack 12 to the attachment part 11c of the tool main body 11 will be explained. As shown in FIG. 1, the battery pack 12 is attached to the attachment part 11c of the tool main body 11 by moving the battery pack 12 and the tool main body 11 to be closer to each other and moving the battery pack 12 along the guide rails 27. In the process of attaching the battery pack 12 to the attachment part 11c, the tool-side terminals 15 are inserted in the terminal insertion holes 28 of the cover 24, and the tool-side terminals 15 and the battery-side terminals 21 are connected with each other.

Then, when the claws of the latches 52 are engaged with the grooves of the attachment part 11c, the operation of attaching the battery pack 12 to the attachment part 11c is completed. When the electric motor 13 of the electric power tool 10 is rotated, the motive power of the electric motor 13 is transmitted to the tip tool 14.

On the other hand, when the operation button 50 is pressed in a state in which the battery pack 12 is attached to the tool main body 11, the claws of the latches 52 are detached from the grooves of the attachment part 11c. Then, when the battery pack 12 and the tool main body 11 are relatively moved in the direction opposite to the above-described one, the battery pack 12 can be detached from the tool main body 11.

The battery pack 12 of the present embodiment is characterized in a point that the holder 17, which is holding the plurality of battery cells 16, and the circuit board 20 are housed in a sealed container 40. The sealed container 40 corresponds to a covering container of the present invention. Hereinafter, embodiments of the battery pack 12 will be sequentially explained.

### First Embodiment

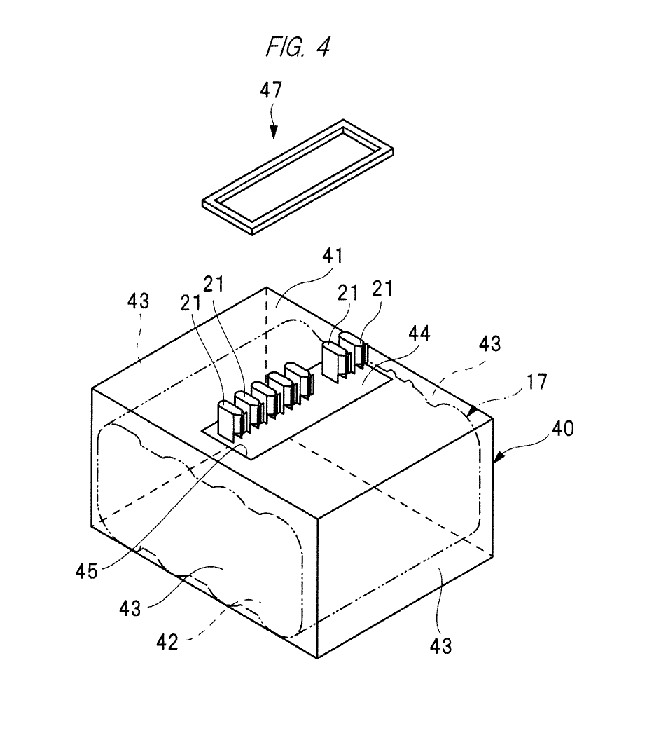

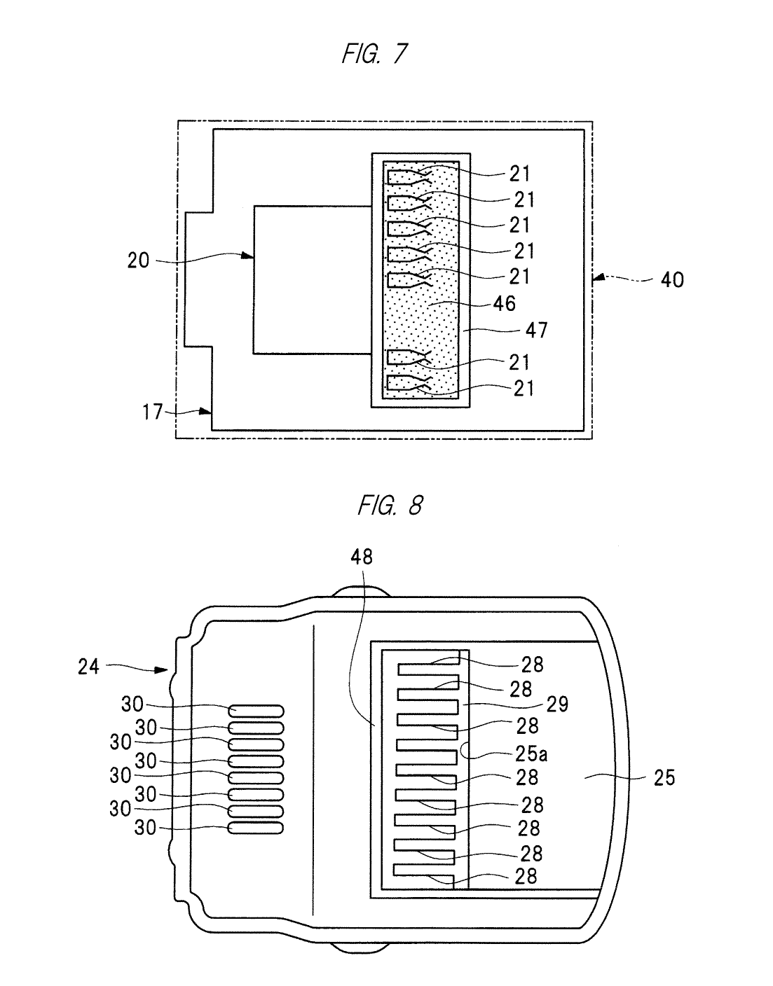

A characteristic structure example 1 of the battery pack 12 will be explained based on FIG. 4 to FIG. 8. The sealed container 40 is integrally formed of a resin material having an electrical insulating property such as polyethylene terephthalate, polyvinyl chloride, or polystyrene. The sealed container 40 has a cuboidal outer shape and has a top plate 41 and a bottom plate 42, which are rectangular, and four lateral plates 43 connecting the top plate 41 and the bottom plate 42. The sealed container is not limited to a cuboid, but may have a shape that fits the shape of the battery cells 16 retained in the holder 17.

An opening portion 44 serving as a window part of the present invention is provided on the top plate 41, and the plurality of battery-side terminals 21 are exposed from the opening portion 44 to the outside of the sealed container 40. When the sealed container 40 is viewed in a plan view, the opening portion 44 is rectangular, and the entire area of an edge 45 forming the opening portion 44 in the top plate 41 is fixed to the surface of the circuit board 20 via a bonding part 46. More specifically, the bonding part 46 is formed by embedding a bonding agent in the gap between the edge 45 and the surface of the circuit board 20 and solidifying the bonding agent. The bonding part 46 seals the part between the sealed container 40 and the circuit board 20. Silicon, urethane, etc. can be used as the bonding agent that forms the bonding part 46. The bonding part 46 corresponds to a seal part of the present invention. Furthermore, a fixing member 47 is provided on the top plate 41 so as to surround the opening portion 44. The fixing member 47 corresponds to a wall part of the present invention. When the sealed container 40 is viewed in a plan view, the shape of the fixing member 47 is endless, specifically, has a rectangular frame-like shape similar to the shape of the edge 45 of the opening portion 44. The fixing member 47 is formed of a resin having an electrical insulating property such as a rubber-like elastic body. When the cover 24 is attached to the case main body 23, the rib 48 is brought into contact with the fixing member 47, and the fixing member 47 is pushed against the outer surface of the sealed container 40. More specifically, among four sides of the fixing member 47, the three sides are held by the rib 48.

As described above, the battery cells 16, the holder 17, and the circuit board 20 are housed in the sealed container 40, and the opening portion 44 of the sealed container 40 is sealed by the bonding part 46. Therefore, even when foreign matters such as water, dust, mud, etc. present outside of the housing case 18 enter the inside of the housing case 18 through the vent holes 30, 31, the window 29, the terminal insertion holes 28, gaps between the cover 24 and the case main body 23, etc., the foreign matters can be prevented from entering the inside of the sealed container 40 through the opening portion 44. In other words, the foreign matters can be prevented from bonding to the battery cells 16, electrodes, etc. Moreover, the opening portion 44 can be easily covered by bringing the bonding part 46 into contact with the circuit board 20.

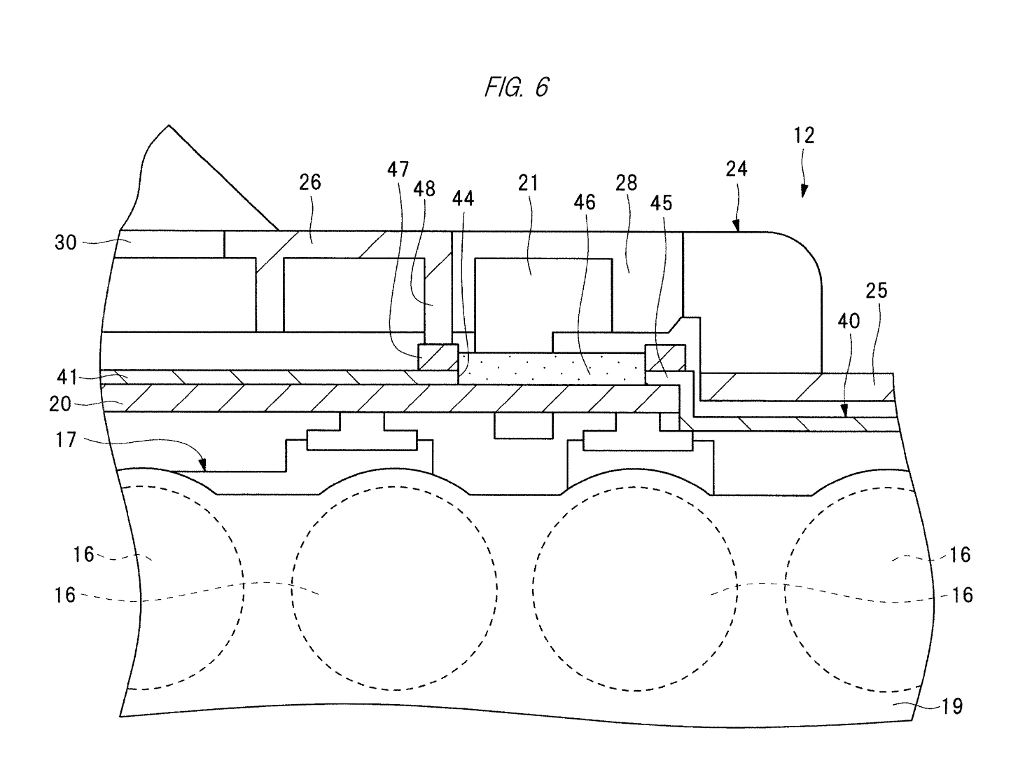

The fixing member 47 may be bonded or welded to the sealed container 40. If the sealed container 40 to which the fixing member 47 is bonded or welded is used, when the sealed container 40 and the circuit board 20 are to be fixed by the bonding part 46, the bonding agent is applied to the region surrounded by the fixing member 47. The bonding agent may be injected or poured into the region surrounded by the fixing member 47. As a result, the fixing member 47 regulates the flowing range thereof before the bonding agent is solidified, and the bonding agent can be prevented from spreading to the part outside the target bonding range. Therefore, the sealing property between the sealed container 40 and the circuit board 20 is improved. The thickness of the bonding part 46 may be equal to or less than the thickness of the sealed container 40. The thickness of the bonding part 46 is in the top-bottom direction in FIG. 6.

Furthermore, when the cover 24 covers the case main body 23, wherein the rib 48 is pushed against the fixing member 47, the edge 45 of the sealed container 40 can be prevented from being corrugated. Moreover, foreign matters can be prevented from passing through the part between the fixing member 47 and the sealed container 40. Therefore, the sealing property is further improved.

Even in a case in which the battery pack 12 is provided with the vent holes 30 and 31, the battery cells 16 are covered with the sealed container 40, and the part between the edge 45 of the sealed container 40 and the circuit board 20 is sealed with the bonding part 46; therefore, foreign matters can be prevented from entering the inside of the sealed container 40.

### Second Embodiment

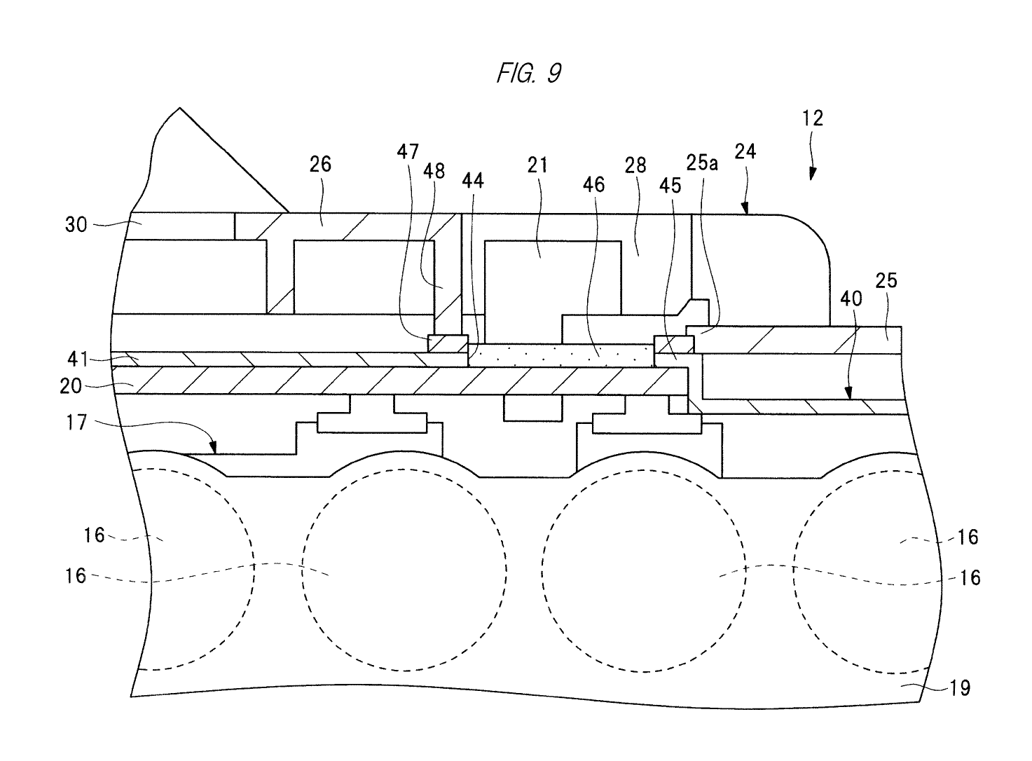

Another structure example 2 of the battery pack 12 will be explained based on FIG. 9. The structure that holds the fixing member 47 of the battery pack 12 shown in FIG. 9 is different from the battery pack 12 of FIG. 5 and FIG. 6. In the battery pack 12 of FIG. 9, when the cover 24 covers the case main body 23, the edge 25a of the plate part 25 holds the fixing member 47. The other configuration of the battery pack 12 is the same as the configuration of the battery pack 12 of FIG. 5 and FIG. 6. Also with the battery pack 12 of FIG. 9, the effects similar to those of the battery pack 12 of FIG. 5 and FIG. 6 are obtained.

Moreover, in the battery pack 12 of FIG. 9, the rib 48 is pushed against three sides of the fixing member 47, which is rectangular in a planar view, and the edge 25a is pushed against one side of the fixing member 47. Thus, all of the four sides of the fixing member 47 are held. Therefore, the sealing property between the circuit board 20 and the sealed container 40 is further improved. In the battery pack 12 of FIG. 9, the rib 48 and the edge 25a correspond to a holding part of the present invention.

### Third Embodiment

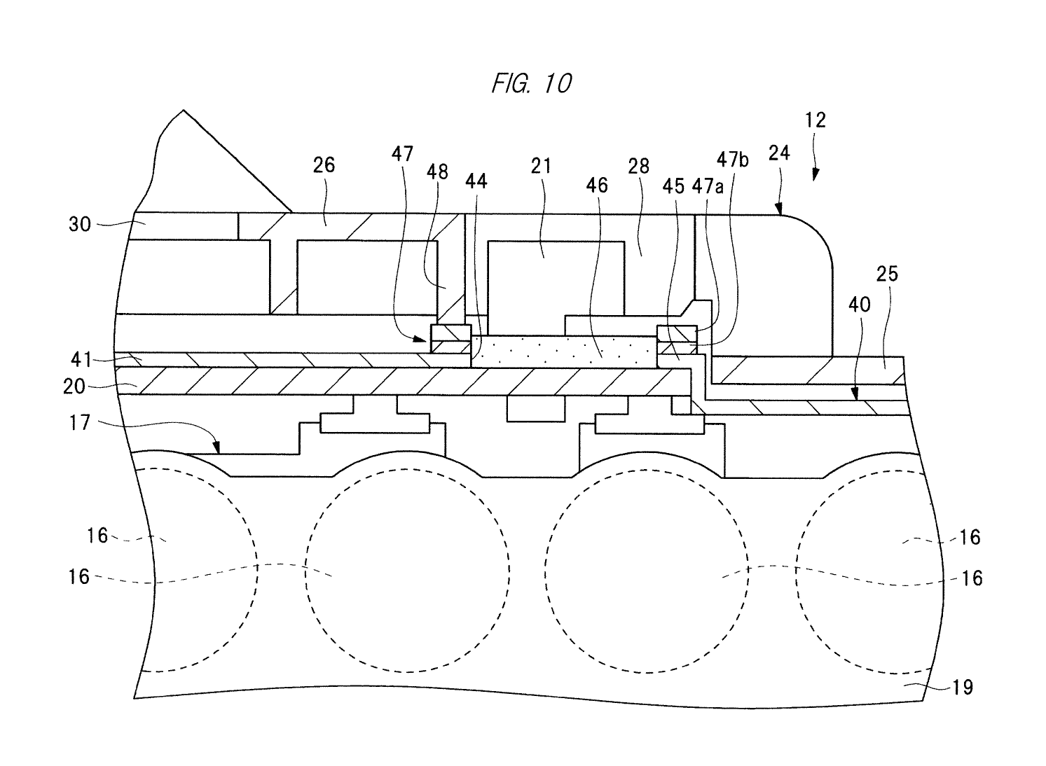

Another structure example 3 of the battery pack 12 will be explained based on FIG. 10. The structure of the fixing member 47 of the battery pack 12 of FIG. 10 is different from that of the battery pack 12 of FIG. 5 and FIG. 6. As shown in FIG. 10, the fixing member 47 has a resin part 47a and a rubber part 47b. Both of the resin part 47a and the rubber part 47b have electrical insulating properties, and the resin part 47a and the rubber part 47b are integrated by two-layer molding. The rubber part 47b contacts the edge 45 at the outer surface of the sealed container 40, and the rib 48 is pushed against the resin part 47a.

The other configuration of the battery pack 12 of FIG. 10 is the same as the configuration of the battery pack 12 of FIG. 5 and FIG. 6. Also with the battery pack 12 of FIG. 10, effects similar to those of the battery pack 12 of FIG. 5 and FIG. 6 are obtained.

Furthermore, since the fixing member 47 is formed of an elastically deformable member, if the fixing member 47 is configured to be larger or thicker than the distance between the circuit board 20 and the rib 48, the sealing property can be further improved when the rib 48 is pushed against the fixing member 47.

### Fourth Embodiment

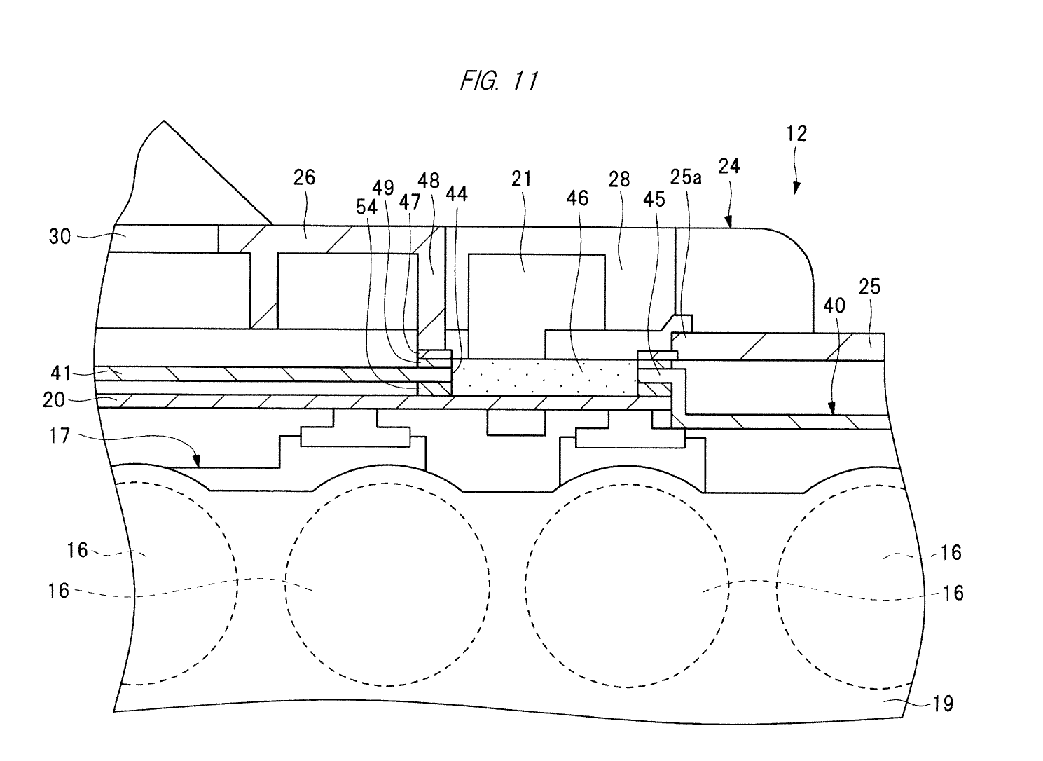

Another structure example 4 of the battery pack 12 will be explained based on FIG. 11. The structure of the fixing member 47 of the battery pack 12 of FIG. 11 is different from the battery pack 12 of FIG. 9. As shown in FIG. 11, the fixing member 47 is fixed to the edge 45 of the sealed container 40 by a double-sided tape 49. Moreover, the edge 45 of the sealed container 40 is fixed to the surface of the circuit board 20 by a double-sided tape 54. In other words, the double-sided tapes 49 and 54 are in contact with the inner surface and outer surface of the sealed container 40. When the sealed container 40 is viewed in a plan view, the double-sided tapes 49 and 54 are rectangularly pasted along the edge 45. In the battery pack 12 of FIG. 11, the fixing member 47 and the double-sided tapes 49 and 54 correspond to the wall part of the present invention.

Furthermore, in a state in which the cover 24 is attached to the case main body 23, the rib 48 and the edge 25a of the plate part 25 are pushed against the fixing member 47. Then, a bonding agent is applied to the region surrounded by the opening portion 44 and the double-sided tapes 49 and 54 and solidified, thereby forming the bonding part 46. The other configuration of the battery pack 12 of FIG. 11 is the same as the configuration of the battery pack 12 of FIG. 9. Also with the battery pack 12 of FIG. 11, effects similar to those of the battery pack 12 of FIG. 9 are obtained. The double-sided tapes 49 and 54 work as elastic bodies.

### Fifth Embodiment

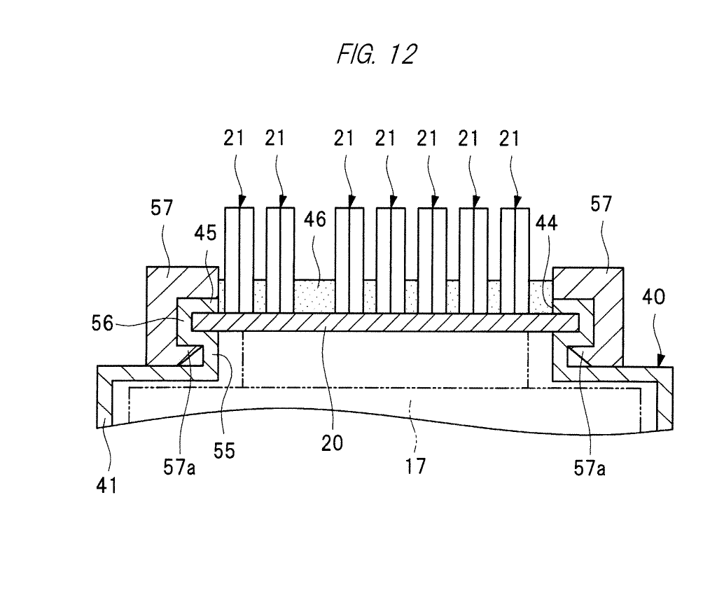

A structure example of the sealed container 40 which can be used for the battery pack 12 of FIG. 2 and FIG. 3 will be explained based on FIG. 12. In FIG. 12, the sealed container 40 is provided with a board supporting part 56 via a neck part 55 continued to the top plate 41. The opening portion 44 is formed in the board supporting part 56. The board supporting part 56 is formed in a U-shape so as to be bulged from the neck part 55 to a lateral side.

The circuit board 20 is attached to the inner side of the board supporting part 56. Fixing members 57 are provided from the outer side of the neck part 55 to the outer side of the board supporting part 56 and to upper parts of the board supporting part 56. The fixing members 57 correspond to the wall part of the present invention. In total the two fixing members 57 are provided to be respectively in the left and right of the circuit board 20 when the battery pack 12 is viewed from the front. In FIG. 2, the front of the battery pack 12 is the part on which the vent holes 31 are provided.

The fixing members 57 are formed of a resin having an electrical insulating property. The fixing member 57 is formed into a U-shape when the battery pack 12 is viewed from the front, and a tip of a claw 57a provided on the fixing member 57 is in contact with the neck part 55. Thus, the edge of the circuit board 20 is sandwiched by the fixing member 57 together with the board supporting part 56. The bonding part 46 is provided between the two fixing members 57 of the board on the circuit board 20, and the edge 45 of the sealed container 40 is fixed to the surface of the circuit board 20. In a state in which the cover 24 is not covering the case main body 23 as shown in FIG. 3, the fixing members 57 shown in FIG. 12 are attached to the sealed container 40. When the sealed container 40 shown in FIG. 12 is used for the battery pack 12 of FIG. 2 and FIG. 3, the part between the sealed container 40 and the circuit board 20 is sealed by the bonding part 46, and effects similar to those described above can be obtained.

### Sixth Embodiment

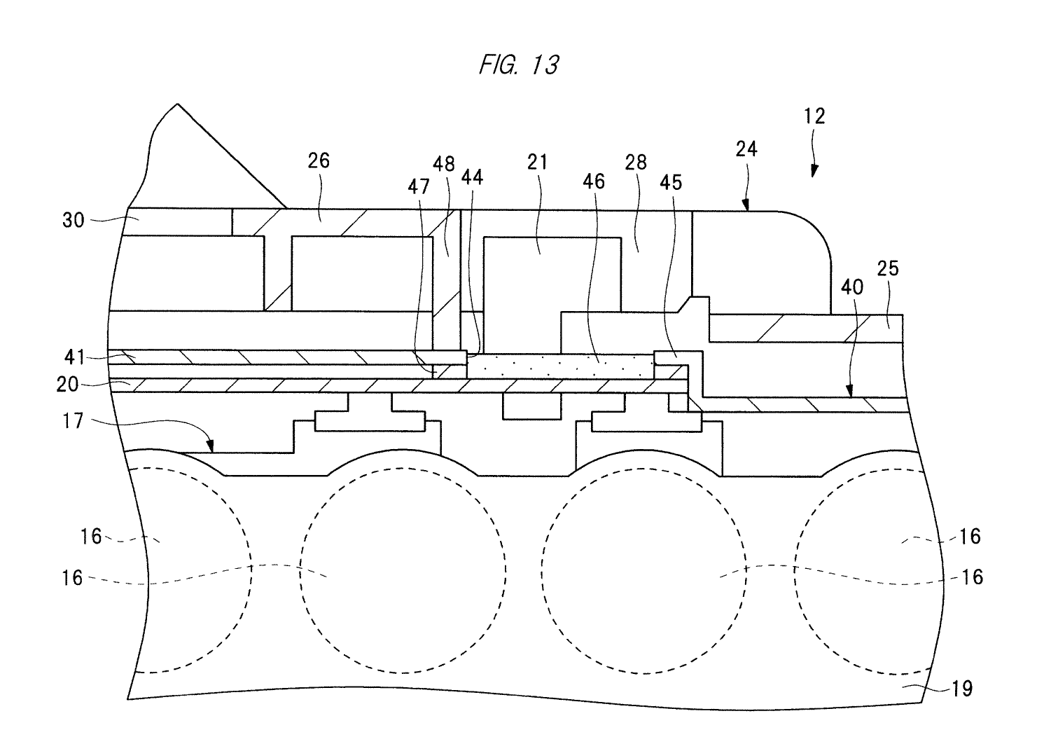

A structure example of the sealed container 40 which can be used for the battery pack 12 of FIG. 2 and FIG. 3 will be explained based on FIG. 13. In FIG. 13, the fixing member 47 is interposed between the circuit board 20 and the top plate 41. Thus, the fixing member 47 is in contact with the inner surface of the sealed container 40. In the sealed container 40 of FIG. 13, the fixing member 47 may be bonded to at least one of the circuit board 20 and the sealed container 40 or may be simply interposed therebetween. Then, the bonding agent fills the region surrounded by the fixing member 47 to the inside of the opening portion 44 and is solidified, thereby forming the bonding part 46. The rib 48 may be in contact with the top plate 41 or may be separated from the top plate 41. The other structure of the battery pack 12 shown in FIG. 13 is the same as the structure of the battery pack 12 of FIG. 5 and FIG. 6. The battery pack 12 shown in FIG. 13 can obtain effects similar to those of the battery pack 12 of FIG. 5 and FIG. 6.

### Seventh Embodiment

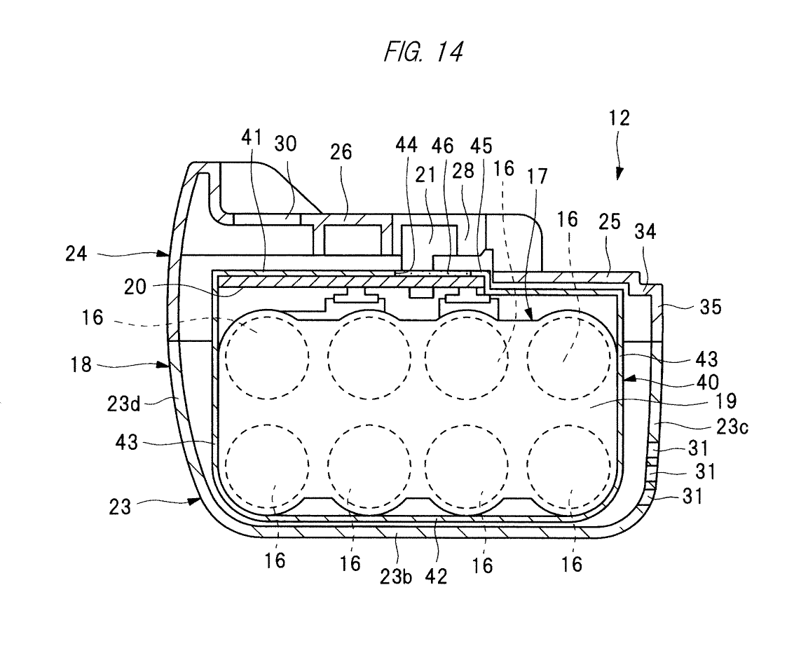

A structure example of the sealed container 40 which can be used for the battery pack 12 of FIG. 2 and FIG. 3 will be explained based on FIG. 14. In FIG. 14, the bonding part 46 is applied to the inside of the opening portion 44, and the top plate 41 and the surface of the circuit board 20 are bonded to each other. The battery pack 12 of FIG. 14 is not provided with the fixing member 47 corresponding to the wall part of the present invention, and the rib 48, which holds the fixing member 47, is also not provided. The other structure of the battery pack 12 shown in FIG. 14 is the same as the structure of the battery pack 12 of FIG. 5 and FIG. 6. In the battery pack 12 shown in FIG. 14, the part between the circuit board 20 and the sealed container 40 is sealed by the bonding part 46.

### Eighth Embodiment

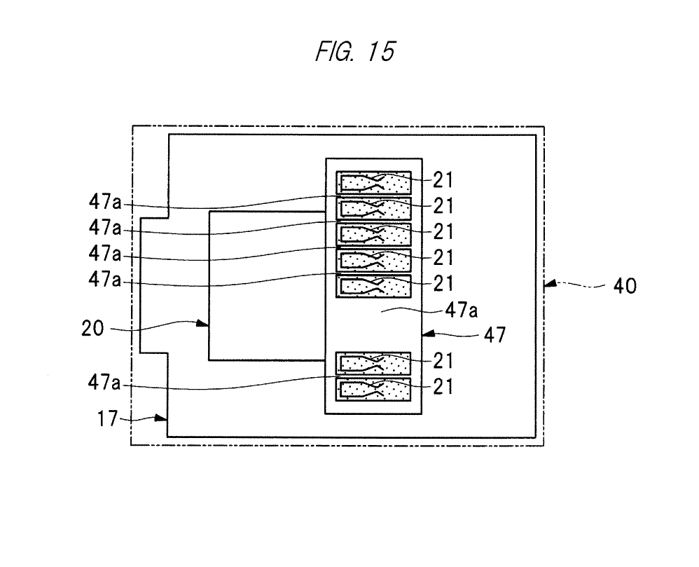

A structure example of the sealed container 40 which can be used for the battery pack 12 of FIG. 2 and FIG. 3 will be explained based on FIG. 15. The fixing member 47 has dividers 47a disposed between the battery-side terminals 21. In the sealed container 40 of FIG. 15, the other configuration of the fixing member 47 and the bonding part 46 is the same as the structure example of FIG. 5 and

FIG. 6. Also, it can be structured so that the rib 48 and the edge 25a of the plate part 25 shown in FIG. 9 are pushed against the fixing member 47 shown in FIG. 15. When the sealed container 40 of FIG. 15 is used in the battery pack 12 of FIG. 2 and FIG. 3, effects similar to the cases in which the sealed container 40 of FIG. 5 and FIG.

6 and the sealed container 40 of FIG. 9 are used can be obtained.

### Ninth Embodiment

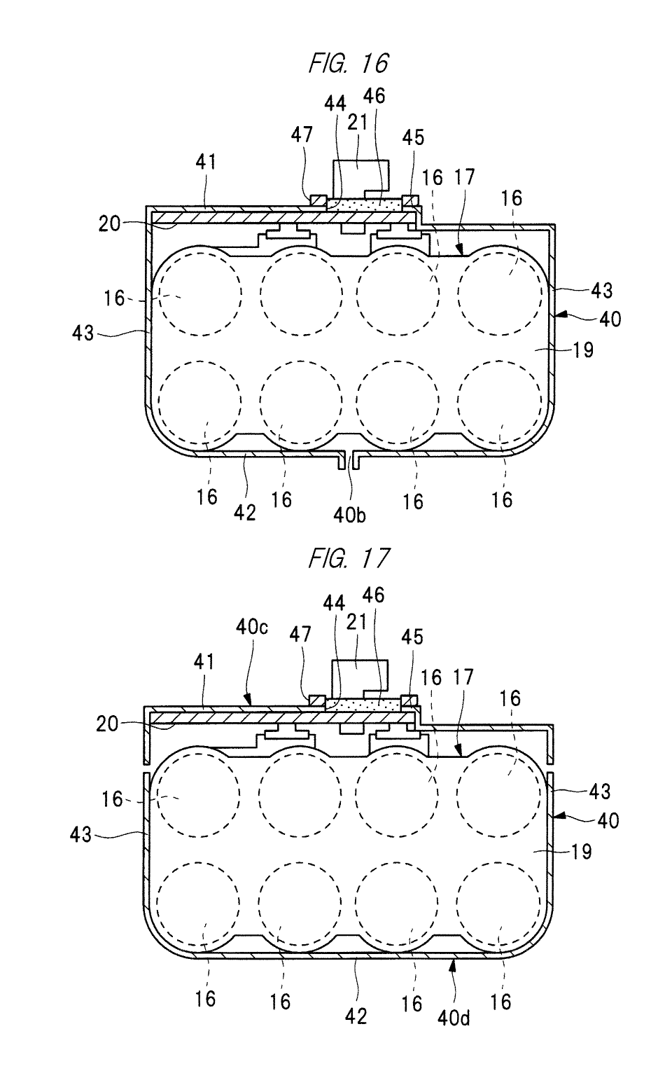

A manufacturing example of the above-described various sealed containers 40 will be explained based on FIG. 16. At the point when the holder 17 and the circuit board 20 are inserted in the sealed container 40, the part corresponding to the bottom plate 42 of the sealed container 40 is open. The opening portion of the sealed container 40 is narrowed to form a degassing hole 40b. Vacuuming from the degassing hole 40b is carried out to vacuum the inside of the sealed container 40, and the vicinity of the degassing hole 40b of the sealed container 40 is heated and welded by a sealer to close the degassing hole 40b. The degassing hole 40b corresponds to a hole of the present invention. The battery cell 16, the circuit board 20, the holder 17, etc. correspond to parts of the present invention.

The members such as the battery cells 16 housed in the sealed container 40 can be housed from the degassing hole 40b.

### Tenth Embodiment

Another structure example of the above-described various sealed containers 40 will be explained based on FIG. 17. At the point when the holder 17 and the circuit board 20 are inserted in the sealed container 40, the sealed container 40 is divided into upper/lower two divided bodies 40c and 40d. Then, the outer peripheral edges of the divided bodies 40c and 40d are bonded to each other by, for example, a bonding agent, a tape, or a sealer to manufacture the sealed container 40. Thus, the sealed container 40 is formed by coupling the two divided bodies 40c and 40d.

The battery pack of the present invention is not limited to the above-described embodiments, and various modifications can be made within a range that does not depart from the gist thereof. For example, the fixing member explained in the embodiments is not required to be removed after solidification of the bonding agent.

The battery pack of the present invention includes a structure that houses less than eight battery cells or a structure that houses nine or more battery cells. Examples of the electric device to/from which the battery pack of the present invention is attached and detached include, in addition to the above-described electric power tool, grinders, sanders, nailing machines, screw driving machines, tackers, dust collectors, air blowers, pumps, high-pressure washing machines, chain saws, grass cutters, clippers, and cultivators.

Thus, examples of the electric device of the present invention include a device that rotates an electric motor by the electric power of a battery pack and converts the rotary motion thereof to at least one of reciprocating motion and rotary motion of a working member.

Also, examples of the electric device of the present invention include a torch. Thus, examples of the electric device of the present invention include lighting equipment that converts the electric energy supplied from the battery pack to optical energy.

What is claimed is:

1. A battery pack comprising:
a housing case that houses a battery cell and can be attached to and detached from an electric-device main body;
a retaining member that retains a battery-side terminal connected to the battery cell;
a covering container that is housed in the housing case and covers the battery cell;
a window part that is provided on the covering container and exposes the battery-side terminal to outside of the covering container; and
a seal part that seals apart between an edge forming the window part and the retaining member.

2. The battery pack according to claim 1,
wherein the retaining member includes a circuit board provided with an electric circuit connected to the battery-side terminal.

3. The battery pack according to claim 1,
wherein the seal part is interposed between the edge and the retaining member.

4. The battery pack according to claim 1,
wherein a wall part that contacts the covering container and surrounds the seal part is provided.

5. The battery pack according to claim 4,
wherein the wall part is in contact with at least one of an outer surface and an inner surface of the covering container.

6. The battery pack according to claim 1,
wherein the housing case includes
a case main body that houses the covering container and
a cover that covers the case main body,
the cover including
a terminal insertion hole into which the battery-side terminal is inserted, and
a holding part that pushes the wall part against the covering container.

7. The battery pack according to claim 6,
wherein the wall part sandwiches the covering container and the circuit board.

8. A battery pack comprising:
a housing case that houses a battery cell and can be attached to and detached from an electric-device main body;
a retaining member that retains a battery-side terminal connected to the battery cell;
a covering container that covers the battery cell;
a window part that is provided on the covering container and exposes the battery-side terminal to outside of the covering container;
a case that includes
a case main body having an opening portion in an upper side and housing the covering container, and
a cover covering the opening portion and provided with a terminal insertion hole exposing the battery-side terminal to outside of the case main body; and
a seal part that prevents a foreign matter from entering inside of the covering container through the window part.

9. The battery pack according to claim 8,
wherein the retaining member includes a circuit board provided with an electric circuit connected to the battery-side terminal;
the circuit board is disposed above the battery cell; and
the window part is positioned above the circuit board.

10. The battery pack according to claim 9,
wherein the covering container has a hole that penetrates through inside and outside of the covering container; and
the hole is closed after a part to be housed in the covering container is housed from the hole.

11. The battery pack according to claim 9,
wherein the covering container is formed by coupling two divided bodies.

12. An electric device comprising:
a battery pack including a housing case that houses a battery cell and can be attached to and detached from an electric-device main body, a retaining member that retains a battery-side terminal connected to the battery cell, a covering container that is housed in the housing case and covers the battery cell, a window part that is provided on the covering container and exposes the battery-side terminal to outside of the covering container, and a seal part that seals apart between an edge forming the window part and the retaining member; and
an electric-device main body to and from which the battery pack can be attached and detached.
